(19) United States
(12) Patent Application Publication
(10) Pub. No.: US 2023/0326082 A1
(43) Pub. Date: Oct. 12, 2023

(54) SYSTEM AND METHOD TO MEASURE QUANTITATIVE ATTRIBUTES IN VIDEOS THROUGH A WEB BROWSER

(71) Applicant: DISCOVERY EDUCATION, INC., Charlotte, NC (US)

(72) Inventors: Peter BOHACEK, Afton, MN (US); Adrian ROCKE, South St. Paul, MN (US); Doug DUNN, Woodbury, MN (US); Eric FRIBERG, West St. Paul, MN (US); Katie GLEASON, St.Paul, MN (US); Matthew VONK, Minneapolis, MN (US); William HEUER, West St. Paul, MN (US)

(21) Appl. No.: 18/297,407

(22) Filed: Apr. 7, 2023

Related U.S. Application Data
(60) Provisional application No. 63/362,705, filed on Apr. 8, 2022.

(51) Int. Cl. G06T 7/90

(52) U.S. Cl. CPC G06T 7/90; G06T 2207/10016; G06T 2207/20092; G06T 2207/10024; G06T 2207/10064

(57) ABSTRACT

Aspects of the present disclosure include devices, systems, methods for determining one or more quantitative attributes of an object contained in a video. Devices, systems, and methods may include receiving image data from a video comprising the object; extracting pixel data from a selected portion of the video comprising the object, wherein the video does not directly contain information of the quantitative attribute to be determined; determining, via the processor, a measurement of the quantitative attribute of the object based on the extracted pixel data; and displaying, by a display unit, a measurement of the quantitative attribute of the object based on the extracted pixel data.

### CROSS-REFERENCE TO RELATED APPLICATION

This application claims the benefit of U.S. Provisional Patent Application No. 63/362,705, filed Apr. 8, 2022, and hereby incorporates by reference herein the contents of this application in their entirety.

### BACKGROUND

Conventional systems can remotely make measurements through a video image, but also require additional data sources to provide a direct measurement of the property to be quantitatively measured. For example, specialized equipment and video recorders may be used to take an image and provide, for example, temperatures or temperature ranges within the image, among other measurements. However, these systems save the quantitative measurements directly received by sensors within the system along with the video data in order to provide the quantitative measurements from the video.

There are two general classes of existing approaches to using light and color to make quantitative measurements: specialized software to measure specific quantities using dedicated measurement equipment, and general online image analysis that measures color but does not convert the color to specific physical quantities.

For example, although conventional software packages and cellphone apps (interchangeably referred to herein as “apps”) allow users to measure temperature using data from infrared cameras, such software packages and cellphone apps work only with forward-looking infrared (FLIR) proprietary data formats such as, for example, propriety data formats used by Teledyne FLIR, LLC of Wilsonville, Oregon. This limits the usage of such software packages and cellphone applications because they only work with specific data files and only on computers with this software installed. Indeed, even a spectrometer contains a light sensor that converts a light reading to a specific quantity. But again, this is done within a highly specialized instrument. These solutions are highly specialized and work in a narrow range of situations.

The other class of solutions are color measurement tools that extract color data from images. Online tools allow users to upload and measure color values from images. However, existing solutions only allow color measurements from online images. There is no conversion to a quantitative value provided with these systems.

Example aspects described herein are directed at systems and methods for measurement of quantitative attributes in videos through a web browser that may include video quantitative color measurement tools for online video.

In some aspects, a computer-implemented method for determining a quantitative attribute of an object contained in a video includes receiving image data from a video comprising the object. The method includes extracting pixel data from a selected portion of the video comprising the object. The video does not directly contain information of the quantitative attribute to be determined. The method includes determining a measurement of the quantitative attribute of the object based on the extracted pixel data. The method includes displaying, by a display unit, a measurement of the quantitative attribute of the object based on the extracted pixel data.

In some aspects, a non-transitory computer-readable medium for determining a quantitative attribute of an object based on pixel data from a video including the object stores computer-readable instructions such that, when executed, causes a processor to receive a video including pixel data of an object. The pixel data of the object does not directly contain information indicative of the quantitative attribute to be determined. The computer-readable instructions, when executed, cause the processor to display the video via a display unit; receive information indicative of a selection of one or more pixels of the video; extract, based on the information indicative of the selection, pixel data from the video; determine, based on the extracted pixel data, information indicative of the quantitative attribute of the object; and display the information indicative of the quantitative attribute of the object via the display unit.

Additional advantages and novel features of these aspects will be set forth in part in the description that follows, and in part will become more apparent to those skilled in the art upon examination of the following or upon learning by practice of the disclosure.

### BRIEF DESCRIPTION OF THE DRAWINGS

FIG. 1 illustrates an example system configured to support the methods described herein, in accordance with aspects of the present disclosure.

FIG. 2 illustrates an example method of measuring quantitative attributes of an image file described herein, in accordance with aspects of the present disclosure.

FIG. 3 illustrates an example aspect of a system and method configured to measure quantitative attributes of an image file described herein, in accordance with aspects of the present disclosure.

FIG. 4 illustrates an example graphical user interface (GUI) of the systems described herein, in accordance with aspects of the present disclosure.

FIGS. 5A and 5B illustrate another example GUI of the systems described herein, in accordance with aspects of the present disclosure.

FIGS. 6A and 6B illustrate yet another example GUI of the systems described herein, in accordance with aspects of the present disclosure.

### DETAILED DESCRIPTION

The following detailed description illustrates by way of example, not by way of limitation, the principles of aspects of the disclosure. This description will clearly enable one skilled in the art to make and use the disclosure, and describes several aspects, adaptations, variations, alternatives and uses of the disclosure, including what is presently believed to be the best mode of carrying out the disclosure. It should be understood that the drawings are diagrammatic and schematic representations of example aspects of the disclosure, and are not limiting of the present claims, nor are they necessarily drawn to scale.

Example aspects described herein are directed at systems and methods for measurement of quantitative attributes in videos through a web browser that may include video quantitative color measurement tools for online video.

Example aspects of the system and methods described herein may enable users to make quantitative measurements of physical parameters such as temperature, light absorption, biological population density, enzyme activity, and many others, using a draggable tool that is part of an online video player. The method can be executed, for example, in any modern web browser and may not rely on proprietary image or video formats. Example aspects described herein may enable scientific analysis of many types of scenarios using online video. This is an improvement over conventional systems that enable users to make quantitative measurements of physical parameters because specialized equipment and proprietary data formats from the specialized equipment to determine the quantitative measurements of the physical parameters. Instead, the systems and methods described herein may be configured to determine quantitative measurements of physical parameters based on red, green, blue (RGB) pixel data from the online video.

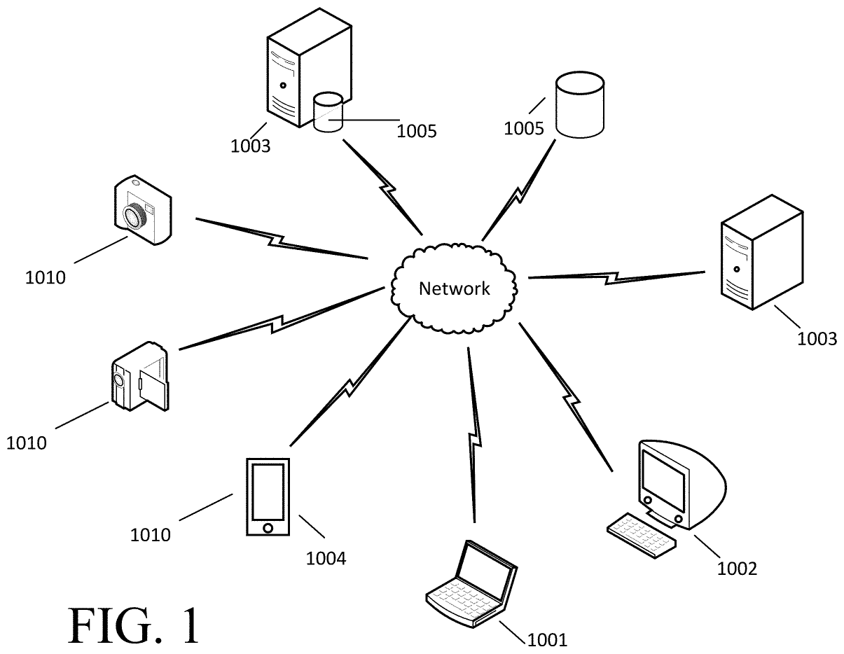

FIG. 1 illustrates an example system for determining quantitative properties of objects within image files according to aspects described herein. Example aspects of the system described herein may include a computer, computers, electronic device, or electronic devices. As used herein, the term computer(s) and/or electronic device(s) are intended to be broadly interpreted to include a variety of systems and devices including personal computers 1002, laptop computers 1001, mainframe computers, servers 1003, set top boxes, digital versatile disc (DVD) players, mobile phone 1004, tablet, smart watch, smart displays, televisions, and the like. A computer can include, for example, processors, memory components for storing data (e.g., read only memory (ROM) and/or random access memory (RAM), other storage devices, various input/output communication devices and/or modules for network interface capabilities, etc. For example, the system may include a processing unit including a memory, a processor, an analog-to-digital converter (A/D), a plurality of software routines that may be stored as non-transitory, machine readable instruction on the memory and executed by the processor to perform the processes described herein. The processing unit may be based on a variety of commercially available platforms such as a personal computer, a workstation, a laptop, a tablet, a mobile electronic device, or may be based on a custom platform that uses application-specific integrated circuits (ASICs) and other custom circuitry to carry out the processes described herein. Additionally, the processing unit may be coupled to one or more input/output (I/O) devices that enable a user to interface to the system. By way of example only, the processing unit may receive user inputs via a keyboard, touchscreen, mouse, scanner, button, or any other data input device and may provide graphical displays to the user via a display unit, which may be, for example, a conventional video monitor. The system may also include one or more large area networks, and/or local networks for communicating data from one or more different components of the system. The one or more electronic devices may therefore input a user interface for displaying information to a user and/or one or more input devices for receiving information from a user. The system may receive and/or display the information after communication to or from a remote server 1003 or database 1005.

As illustrated in FIG. 1, the example system for determining quantitative properties of objects within image files may include an electronic device 1010 for generating the image files. As illustrated, the electronic device 1010 for generating the image files, may be or include a camera, video recorder, mobile phone having camera or video capabilities, and/or sensors that can be used to generate image files. In an example aspect, the electronic device may create a series of sequential images, such as in a video file.

The example system may also be configured to communicate the image files generated from the electronic device over a network. The image files of the electronic device may be stored in memory and transferred wirelessly or wired over a network to another memory, such as in a database 1005 at a server 1003, or another computer, such as laptop 1001 or computer 1002. The two-dimensional images of the electronic device may be extracted from the electronic device with another computer, such as laptop 1001 or computer 1002 before being communicated over the network.

The example system may include a computer 1001, 1002, server 1003, and/or memory in which the system may store the received image files, analyze the received image files, and provide a measurement of a quantitative property of one or more objects within the image files according to aspects described herein. The system may include one or more processors in communication with one or more memories to achieve the desired receiving, analyzing, and providing steps described herein.

The example system may include a computer 1001, 1002 having image viewing capabilities, such as through a browser to permit the display of the image files. The system may be configured to receive inputs from the user through a user interface, such as a mouse, buttons, keypad, etc. and manipulate the display of the image files. The manipulation of the display may include rendering an image related to the quantitative property as provided by the measurement of the one or more objects. The image may include an alpha-numeric string indicating a quantitative measurement. The image may include a color code corresponding to a quantitative measurement or approximating a quantitative measurement. The image may be an icon related to the measurement. The image may be any combination of alpha characters, numeric characters, colors, symbols, icons, or other images.

Example aspects of the system and methods for determining quantitative properties of objects within image files described herein comprise extracting pixel values from regions of interest in a video frame and converting these values to physical quantities using calibration data that relate the physical quantities to the response of the sensor used to capture the video, as described in greater detail herein.

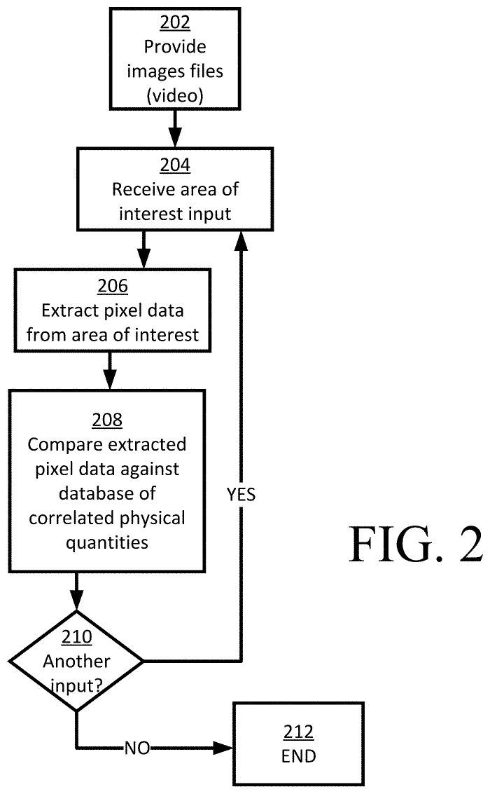

FIG. 2 illustrates an example method for determining quantitative properties of objects within image files according to aspects described herein. In general, the method may include obtaining the image file(s), extracting pixel data from an area of the image file(s), comparing the extracted pixel data to a database of pixel information correlated to one or more quantitative properties of interest, determining a desired quantitative property based on the extracted pixel data.

At step 202, the method for determining quantitative properties of objects may begin by providing one or more image files. In an example aspect, the image file may be a video file comprising a series of sequential image files. The video file may be a pre-recorded video of a scientific experiment or other action under observation. The video file may be stored on a server or memory location and viewable by a user over a network. In an example aspect, the video may be viewed through a network browser. Example aspects of the video file therefore do not require specific or special programs downloaded on the user electronic device in order to play the video file, or the video file itself to be downloaded by the user in order to perform the functions described herein. Example aspects of the system permit the video to play in a browser of the user without downloading of software to the user's local machine.

At step 204, the method for determining quantitative properties of objects within image files may include obtaining an area of interest within the image file. The area of interest may be obtained from a user. In an example aspect, the system may include user inputs, such as through selection of buttons, keys, mouse, etc. on the user's device that are received as input signals to the system. The input signals may permit the user to pause, play, select one or more images from a plurality of sequential images defining a video file, select a point or area of interest within an image, or a combination thereof. For example, the system may be configured to permit the user to use a mouse to select a pause button associated with a video file in order to select a single image file for display on the user's screen. The system may be configured to permit the user to make a selection of an area of interest on the displayed image. For example, the user may select an icon to choose a point or area of interest and select the point or area using a mouse and selection buttons in relation to a point over the image file displayed on the screen. The user may select a selection box or marker and then draw over the area of interest by depressing a mouse button and moving the cursor over the desired area of interest on the displayed image. Other input methods may also be used, such as clicking on a part of the image, identifying an object within the image, or a combination thereof.

In an example aspect, the user may also provide an input for the quantitative property to be determined from the selected area. For example, the user may select properties such as, for example, temperature, density, intensity, luminosity, energy, pH, light absorption, biological population density, enzyme activity, absorbance or concentration of colored liquids or gases, image contrast, etc. In an example aspect, the user may select only properties that are relevant to a given action within the video, such as quantitative properties that are changing through a scientific experiment.

At step 206, the method for determining quantitative properties of objects within image files may include extracting pixel data from the area of interest as received previously in the method. In an example aspect, the extracted pixel data may be red green blue (RGB) color data for one or more pixels. If an area of interest that is received includes more than one pixel, an average or sum of the RGB color data over the area of interest may be extracted.

At step 208, the extracted pixel data may be compared against a database of pixel data corresponding to quantitative properties of interest. The database may include data correlating the pixel data to measured amounts of the properties of interest. If the system includes more than one correlation of quantitative properties, the system may use the received quantitative property from the user to select a database corresponding to the received quantitative property. The system may then compare the extracted pixel data against the selected database corresponding to the received quantitative property to determine a desired quantitative property from the extracted pixel data. The comparison may be across RGB color values to determine a closest match to a corresponding quantitative property.

The system may be configured to display, for example, via the display unit, information related to the desired quantitative property to the user. As described herein, the display may include an alpha-numeric representation of the desired quantitative measurement. Other display methods may include colors, symbols, etc.

At step 210, the method for determining quantitative properties of objects within image files may permit the user to select another area of interest and/or another desired quantitative property to measure. The system may therefore look for another input from the user to make a selection. If the user makes the selection, the system may receive another area of interest, such as at step 204, and/or receive another quantitative property from the user corresponding to the previously selected area of interest. If another area of interest is selected, then the pixel data of the new area of interest may be extracted, such as at step 206. If the previous area of interest is used, then the system may use the previously extracted pixel data. The method may thereafter use the pixel data and/or the received quantitative property to determine a new desired quantitative property, such as at step 208 and display the results to the user. If another input is not received, then the process may end at step 212.

In some aspects, the conversion function can be generated as follows. Although the specific example referred to herein is for population density, it will be apparent that conversion functions for other quantitative properties can determined in a similar manner. In the present example, a video of a algal growth is recorded in the presence of white light with broad spectral distribution. One or more images from the video can be used to measure the rate of growth of the algae as follows. At one or more points of time during the algal growth, a sample is taken from the algae and the population density is measured using a hemocytometer slide. For example, serial dilutions are performed and population density measurements are made of each of the dilutions. The color of each dilution is sampled using, in this case, the blue channel. A plot of blue light absorbance vs algae population is created, and a conversion function is extracted from the data. For example, a regression model may be used to extract the conversion function from the data. The conversion function is integrated into the web browser software so that the blue channel value can be converted to an algal population density. Once this calibration is complete, the system can measure algae population data from similar video. In some aspects, the conversion function and/or the extracted data can be used to generate one or more databases corelating the RGB color data to the measured quantitative data. For example, in the present example, the database may correlate particular values of blue light absorbance to particular algae population densities.

In a specific aspect of the example system and method for determining quantitative properties of objects within image files, a user may measure the growth of algae. At step 202, the system may provide a video showing the growth of algae in a specimen flask. The user may pause the growth video during any stage of the growth, and click the color tool on a portion of the image within the specimen flask to measure the instantaneous population density for that selected portion of the image. For example, the system can extract the pixel data from the selected portion of the image. The system can then determine, based on the conversion function and/or the database, the population density based on color data included in the extracted pixel data. The system can then displayed the determined population density to the user by the display unit. Values can, therefore, be read, recorded, and graphed to show the rate of population growth.

Example aspects of the system and method for determining quantitative properties of objects within image files may use any combination of conversion functions to convert from light intensity to quantitative measurements, such as, for example: RGB values to pH using colored indicators; greyscale to absorbance or concentration of colored liquids or gases; RGB values to blackbody temperature; greyscale to enzyme activity using fluorescence; variation in light intensity across a resolution target to determine microorganism population; stellar photometry, for example to determine the luminosity and/or temperature of stars using images captured by telescopes such as the Hubble or James Webb telescopes, and any combination thereof.

Example aspects described herein may permit a user to upload a video in order to perform their own measurements. The user may perform calibrations, and then convert color values to numeric quantities.

Example aspects of the system and methods described herein may be adapted to many types of thermal images and use standard image and video formats (jpeg, mp4). The aspects described herein may embed the conversion factors, correlational databases, conversion factors, and/or calculation of the corresponding pixel data to desired quantitative properties into the web app software, automatically converting the image colors to physical values. The conversion factors can be set by the user, or drawn from a library of predetermined conversion functions. The ability to go directly to physical quantities enables more rapid analysis.

The computing devices described herein are non-conventional systems at least because of the use of non-conventional component parts and/or the use of non-conventional algorithms, processes, and methods embodied, at least partially, in the programming instructions stored and/or executed by the computing devices. The systems and methods described herein include improved systems and methods for obtaining a quantitative property of an object within an image without the sensors or conventional measurement tools to directly measure the quantitative property. Instead, example aspects of the system and method described herein include an extraction of pixel data including some variation of color, grey scale, or combination thereof to determine the corresponding quantitative property. Example aspects of the systems and methods described herein have advantages over the existing methods. Compared to specialized solutions such as FLIR's dedicated system, the aspects of the system and methods described herein may be scalable and portable because the web-app runs in a web browser rather than needing specialized software installed on every device. In addition, example aspects of the system and method described herein may be used with standard image formats, making it more broadly useful on any device. Example aspects described herein may be used to determine many different measured quantities once the calibration is established and integrated into the browser software. This allows the user to measure a larger range of physical quantities from the color values in an image compared to existing methods of using color measurements requiring specialized software running on their device.

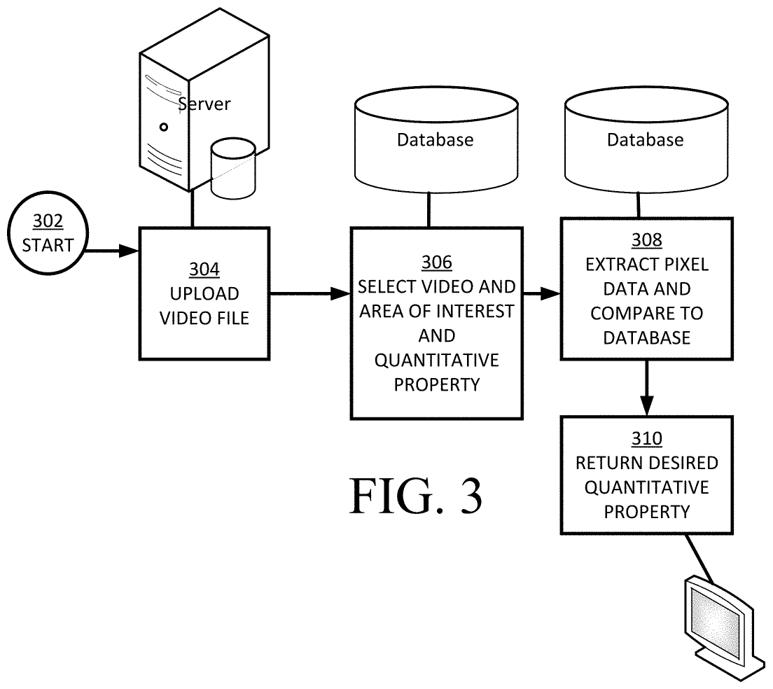

FIG. 3 illustrates an example aspect of a system and method for determining quantitative properties of objects within image files. At step 302, the method may start. A user may take a video file of an action or event of interest and upload the video file at step 304. The user may be an administrator or system controller, or may be the user that measures quantitative properties at later steps of the method. As illustrated, the system may use a server to communicate the uploaded video file and store within a database. At step 306, the same or another user may then select a desired video, area of interest, experiment, or type of subject or test to be conducted, and/or quantitative property to be measured through their web browser. The system, as illustrated, may retrieve the selected video from the database and display it to the user over a web browser. The user may then manipulate the video and make the desired selections according to aspects described herein. At step 308, the system may extract the pixel data. The extracted pixel data may be any of one or more of the RGB colors, grey scale value, contrast, or other pixel information. The extracted pixel data is not a direct measurement of the quantitative property. As illustrated, the system may then compare the extracted pixel data against a database of pixel data and corresponding quantitative property measurements in order to retrieve the desired quantitative property corresponding to the extracted pixel data. At step 310, the results of the desired quantitative measurement is displayed to the user on a display screen through the browser.

Instead of looking up a corresponding pixel data within a database as illustrated in FIG. 3, the system may be configured to determine a conversion factor and/or function in order to calculate the quantitative property from the extracted pixel data. In this aspect, the system may use the database of correlations between pixel data and corresponding quantitative properties to determine the conversion factor and/or function. The system may use statistical analysis to determine the conversion factor and/or conversion function. The system may then use the conversion factor and/or conversion function with the extracted pixel data in order to calculate an approximation of the desired quantitative property corresponding to the extracted pixel data. The conversion factor and/or conversion function may be stored in the browser program in order to return faster measurement capabilities to the user. The conversion factor and/or conversion function may also or alternatively be stored in the database and loaded at or after the user selects the desired quantitative property and/or identifies the experiment or source of the subject to be tested.

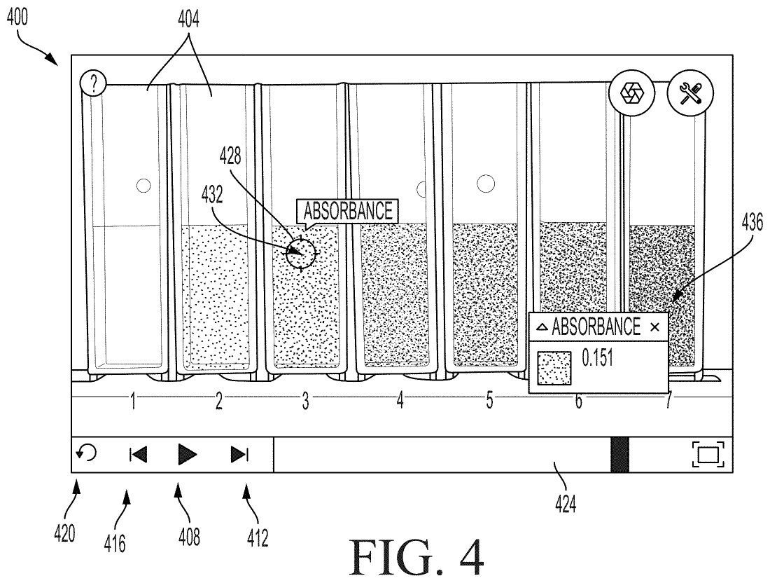

FIG. 4 illustrates an example graphical user interface (GUI) 400 of an aspect of the present disclosure. In FIG. 4, the system is displaying a video including a series of cuvettes 404 including a dissolved complex ion, such as, for example, iron(III)thiocyanate complex ion. The GUI 500 includes user input buttons including a play/pause button 408, a forward button 412, a reverse button 416, a restart button 420, and a status bar 424. The user can select any combination of the user input buttons 408-420 to navigate to a desired portion (e.g., frame) of the video. The user may use the play/pause button 408 to pause the video at the desired portion of the video. In order to determine the one or more absorbance values for the cuvettes 404, the user may select, e.g., via pointer 428, a portion 432 of the image. The system may extract pixel data from the selected portion of the video. The system may then determine, based on a database, conversion function, conversion factor, and so forth, absorbance data based on the extracted pixel data. The system may then display, via a portion 436 of the GUI 400, the conversion data.

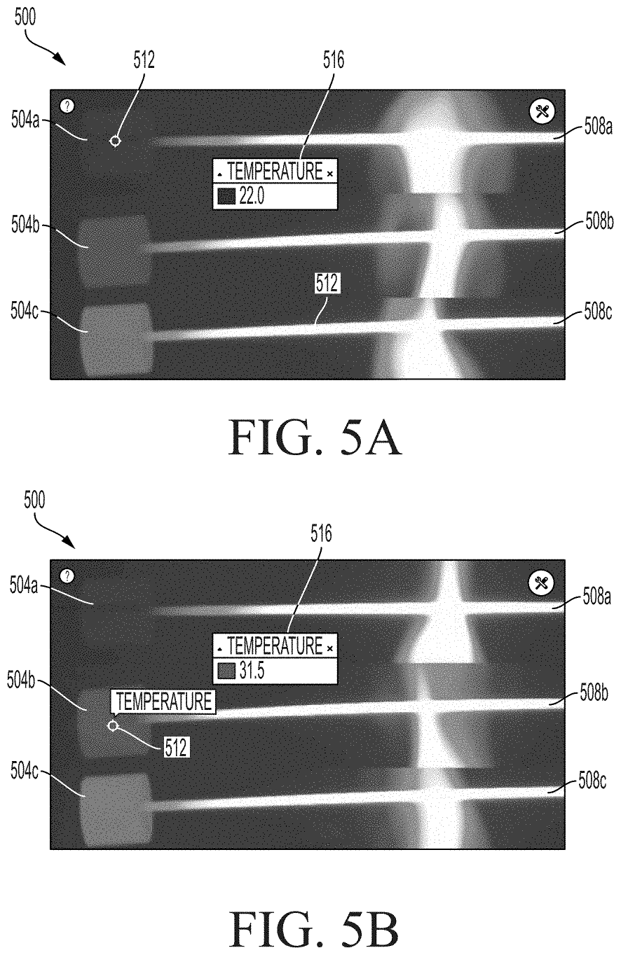

FIGS. 5A and 5B illustrate an example GUI 500 of an aspect of the present disclosure. In FIGS. 5A and 5B, the system is displaying a video including heat being transferred to brass blocks 504a, 504b, 504c by a steel rod 508a, an aluminum rod 508b, and a copper rod 508c, respectively. The user can select, via user input buttons, a desired portion of the video. The user may use the user input buttons to pause the video at the desired portion of the video. In order to determine one or more heat transfer values for the brass blocks 504a-504c, the user may select, e.g., via pointer 512, a portion of the image. The system may extract pixel data from the selected portion of the video. The system may then determine, based on a database, conversion function, conversion factor, and so forth, absorbance data based on the extracted pixel data. The system may then display, via a portion 516 of the GUI 500, data indicative of a temperature of the selected portion of the video. In the example shown in FIG. 5A, the user has selected the brass block 504a, and the temperature shown in 516 is indicative of a temperature of the selected portion of the brass block 504a. In the example shown in FIG. 5B, the user has selected the brass block 504b, and the temperature shown in 516 is indicative of a temperature indicated of the selected portion of the brass block 504b.

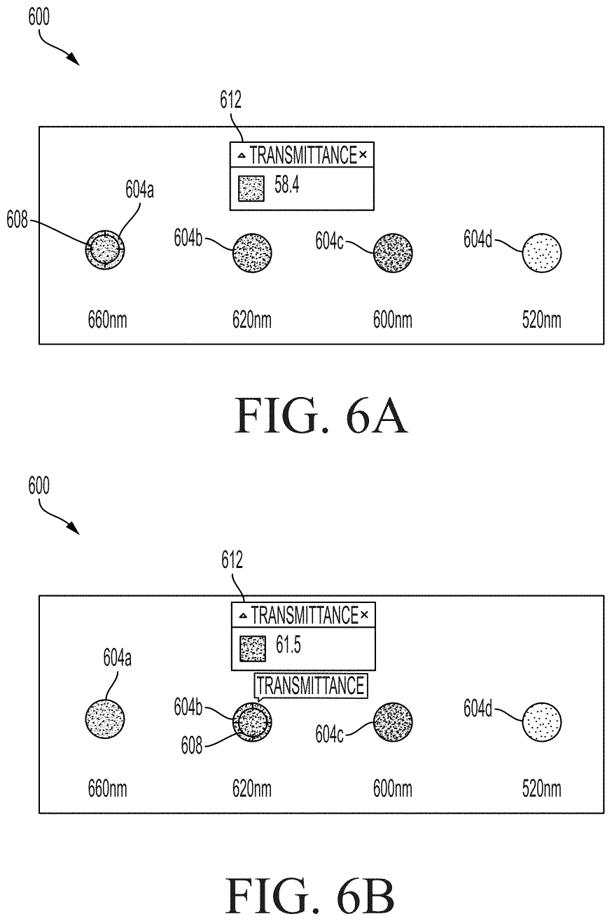

FIGS. 6A and 6B illustrate an example GUI 600 of an aspect of the present disclosure. In FIGS. 6A and 6B, the system is displaying a video showing colored light emitting diodes (LEDs) 604a, 604b, 604c, 604d positioned in a vial of distilled water. The user can select, via user input buttons, a desired portion of the video. The user may use the user input buttons to pause the video at the desired portion of the video. In order to determine one or more light transmittance values for the LEDs 604a-604d, the user may select, e.g., via pointer 608, a portion of the image. The system may extract pixel data from the selected portion of the video. The system may then determine, based on a database, conversion function, conversion factor, and so forth, absorbance data based on the extracted pixel data. The system may then display, via a portion 612 of the GUI 600, data indicative of a light transmittance of the selected portion of the video. In the example shown in FIG. 6A, the user has selected a portion of the LED 604a, and the light transmittance shown in 608 is indicative of the light transmittance of the selected portion of the LED 604a. In the example shown in FIG. 6B, the user has selected a portion of the LED 604b, and the light transmittance shown in 612 is a indicative of a light transmittance of the selected portion of the LED 604b.

Example aspects of the system described herein can be based in software and/or hardware or a combination thereof. While some specific aspects of the systems and methods have been shown, the claims are is not to be limited to these aspects. For example, most functions performed by electronic hardware components may be duplicated by software emulation. Thus, a software program written to accomplish those same functions may emulate the functionality of the hardware components in input-output circuitry. The claims are to be understood as not limited by the specific aspects described herein, but only by scope of the appended claims.

As used herein, the terms “about,” “substantially,” or “approximately” for any numerical values, ranges, shapes, distances, relative relationships, etc. indicate a suitable dimensional tolerance that allows the part or collection of components to function for its intended purpose as described herein. Numerical ranges may also be provided herein. Unless otherwise indicated, each range is intended to include the endpoints, and any quantity within the provided range. Therefore, a range of 2-4, includes 2, 3, 4, and any subdivision between 2 and 4, such as 2.1, 2.01, and 2.001. The range also encompasses any combination of ranges, such that 2-4 includes 2-3 and 3-4.

Although aspects of this disclosure have been fully described with reference to the accompanying drawings, it is to be noted that various changes and modifications will become apparent to those skilled in the art. Such changes and modifications are to be understood as being included within the scope of aspects of this invention as defined by the appended claims. Specifically, example components are described herein. Any combination of these components may be used in any combination. For example, any component, feature, step or part may be integrated, separated, sub-divided, removed, duplicated, added, or used in any combination and remain within the scope of the present disclosure. Aspects are examples only, and provide an illustrative combination of features, but are not limited thereto.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the disclosure in diverse forms thereof.

Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is understood that the specific order or hierarchy of the processes/flowcharts disclosed is an illustration of example approaches. Based upon design preferences, it is understood that the specific order or hierarchy in the processes/flowcharts may be rearranged. Further, some features/steps may be combined or omitted. The accompanying method claims present elements of the various features/steps in a sample order, and are not meant to be limited to the specific order or hierarchy presented.

Further, the word “example” is used herein to mean “serving as an example, instance, or illustration.” Any aspect described herein as “example” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. Nothing disclosed herein is intended to be dedicated to the public regardless of whether such disclosure is explicitly recited in the claims.

What is claimed is:

1. A computer-implemented method for determining a quantitative attribute of an object contained in a video, the computer comprising a processor, a memory and a display, the method comprising:
receiving image data from a video comprising the object;
extracting pixel data from a selected portion of the video comprising the object, wherein the video does not directly contain information of the quantitative attribute to be determined;
determining, via the processor, a measurement of the quantitative attribute of the object based on the extracted pixel data; and
displaying, by a display unit, a measurement of the quantitative attribute of the object based on the extracted pixel data.

2. The computer-implemented method of claim 1, wherein the measurement of the quantitative attribute of the object is determined based on a correlation function based on correlation data between a plurality of pixel data points and a plurality of quantitative attribute values.

3. The computer-implemented method of claim 1, wherein the measurement of the quantitative attribute of the object is determined based on a database including correlation data between a plurality of pixel data points and a plurality of quantitative attribute values.

4. The computer-implemented method of claim 1, further comprising:
receiving a first user input indicative of a desired image frame of the video; and
receiving a second user input indicating the selected portion of the video, wherein the desired image frame includes the selected portion of the video.

5. The computer-implemented method of claim 4, further comprising: receiving a third user input indicating the quantitative attribute of the object to be determined.

6. The computer-implemented method of claim 4, wherein the first user input is received from a pause input on a display of the video file.

7. The computer-implemented method of claim 1, wherein the extracted pixel data comprises greyscale data and the quantitative attribute comprises absorbance or concentration of colored liquids or gases.

8. The computer-implemented method of claim 1, wherein the extracted pixel data comprises red, green, blue (RGB) values and the quantitative attribute comprises blackbody temperature.

9. The computer-implemented method of claim 1, wherein the extracted pixel data comprises greyscale data and the quantitative attribute comprises enzyme activity based on fluorescence.

10. The computer-implemented method of claim 1, wherein the extracted pixel data comprises contrast data and the quantitative attribute comprises a size of a population of non-absorbing microorganisms.

11. A non-transitory computer-readable medium for determining a quantitative attribute of an object based on pixel data from a video including the object storing computer-readable instructions such that, when executed, causes a processor to:
receive a video including pixel data of an object, wherein the pixel data of the object does not directly contain information indicative of the quantitative attribute to be determined;
display the video via a display unit;
receive information indicative of a selection of one or more pixels of the video;
extract, based on the information indicative of the selection, pixel data from the video;
determine, based on the extracted pixel data, information indicative of the quantitative attribute of the object; and
display the information indicative of the quantitative attribute of the object via the display unit.

12. The non-transitory computer-readable medium of claim 11, wherein the video includes a plurality of frames, and wherein the pixel data is extracted from a selected frame of the video.

13. The non-transitory computer-readable medium of claim 11, wherein the non-transitory computer-readable instructions further cause the processor to:
receive information indicative of a type of quantitative attribute to determine based on the extracted pixel data.

14. The non-transitory computer-readable medium of claim 13, wherein the type of quantitative attribute to determine is a first type of quantitative attribute, and wherein the non-transitory computer-readable instructions further cause the processor to:
receive information indicative of a second type of quantitative attribute to determine based on the extracted pixel data.

15. The non-transitory computer-readable medium of claim 11, wherein the quantitative attribute includes one or more of temperature, density, intensity, luminosity, energy, pH, light absorption, biological population density, enzyme activity, absorbance or concentration of colored liquids or gases, image contrast, and combinations of two or more thereof.

16. The non-transitory computer-readable medium of claim 11, wherein the extracted pixel data includes red, green, blue (RGB) color data from the one or more pixels.

17. The non-transitory computer-readable medium of claim 11, wherein the information indicative of the quantitative attribute of the object is determined based on a relational database that includes a correlation of RGB color data to the quantitative attribute.

18. The non-transitory computer-readable medium of claim 11, wherein the information indicative of the quantitative attribute of the object is determined based on a correlation function configured to correlate RGB color data to the quantitative attribute.

19. The non-transitory computer-readable medium of claim 11, wherein selection of one or more pixels of the video is a first selection and the pixel data is first pixel data, and the information indicative of the quantitative attribute of the object is first information indicative of the quantitative attribute of the object, and wherein the non-transitory computer-readable instructions further cause the processor to:
receive information indicative of a second selection of one or more pixels of the video;
extract, based on the information indicative of the second selection, second pixel data from the video;
determine, based on the second extracted pixel data, second information indicative of a second quantitative attribute of the object; and
display the second information indicative of the quantitative attribute of the object via the display unit.

20. The non-transitory computer-readable medium of claim 19, wherein the second quantitative attribute is different from the first quantitative attribute.
